(19) United States
(12) Patent Application Publication
(10) Pub. No.: US 2014/0299220 A1
(43) Pub. Date: Oct. 9, 2014

(54) MULTILAYER STRUCTURE INCLUDING A LAYER OF A SPECIFIC COPOLYAMIDE AND A BARRIER LAYER

(71) Applicants: Thibaut Montanari, Menneval (FR); Fabrice Montezin, Saint Aubin De Scellon (FR); Alexandre Vermogen, Beaumont Le Roger (FR); Philippe Blondel, Bernay (FR); Sylvain Benet, Bernay (FR)

(72) Inventors: Thibaut Montanari, Menneval (FR); Fabrice Montezin, Saint Aubin De Scellon (FR); Alexandre Vermogen, Beaumont Le Roger (FR); Philippe Blondel, Bernay (FR); Sylvain Benet, Bernay (FR)

(73) Assignee: ARKEMA FRANCE, COLOMBES (FR)

(21) Appl. No.: 14/111,209

(22) PCT Filed: Apr. 12, 2012
(86) PCT No.: PCT/EP12/56711

§ 371 Date: Jun. 4, 2014

(30) Foreign Application Priority Data
Apr. 14, 2011 (FR) 11/01176

(51) Int. Cl. B32B 1/08; B32B 27/34; B32B 27/08

(52) U.S. Cl. CPC B32B 1/08; B32B 27/08; B32B 27/34; B32B 2597/00
USPC 138/140; 428/422; 428/413; 137/1

(57) ABSTRACT

The invention relates to a multilayer structure including: a so-called outer layer (L1) consisting of a composition that primarily includes one or more semicrystalline copolyamides (H), the melting point of which is at least 220° C. and which contains at least 80 mol % of the following two units (s) and (a), wherein the (s) unit denotes one or more semiaromatic (s) units consisting of one of more sub-units from aromatic diacid (sr) and one or more sub-units from aliphatic diamine (sa) having 9 to 13 carbon atoms, and the (a) unit denotes one or more aliphatic units having 8 to 13 carbon atoms per nitrogen atom, the molar ratio (s)/(a) being 1 to 3; and a layer (L2) consisting of a composition primarily containing one or more tetrafluoroethylene (TFE) copolymers, said TFE copolymer being necessarily functionalized when layer (L2) is in contact with layer (L1) or with an intermediate layer that primarily includes one or more polyamides. The invention also relates to the uses of said multilayer structure for transporting fluids in the automotive field.

The invention relates to a multilayer structure comprising as its outer layer, a layer of a composition comprising predominantly one or more specific semicrystalline copolyamides and as inner layer, a barrier layer based on specific fluoropolymers, and also to its use for the transfer and/or storage of fluids, such as an oil, a liquid based on urea solution, a fuel, especially an alcoholized fuel, a cooling liquid, a refrigerant fluid, or else engine gas emanations.

In the field of transport and of the automobile more particularly, there are numerous conduits, consisting of polymer-based compositions, which are intended for carrying fluids such as, for example, more or less alcoholized gasolines, cooling liquid (alcohol and water), brake fluid, refrigerant fluids present in the air-conditioning circuit, oil, engine gas emanations, or else urea solutions.

For environmental protection reasons, the conduits and tanks are required to have a good barrier property with respect to such fluids, in order to prevent their loss by evaporation. By barrier property is meant the very low permeability of the material of these conduits and tanks to the fluids stored or transported therein.

From another aspect, for safety reasons, these conduits and tanks must be very robust mechanically and chemically, especially in order to oppose leakage in the event of impact or accident. They must also be sufficiently flexible to allow them to be used in the vehicle, especially when they are being installed.

Pipes and tanks composed of multilayer structures, combining at least one barrier layer as inner layer and a robust polymer layer as outer layer, are in general used. This latter layer may especially be composed of flexible, high-carbon-content aliphatic polyamide with the function, among others, of ensuring the mechanical strength and chemical resistance of the multilayer structure as a whole.

Examples of flexible, high-carbon-content aliphatic polyamides include compositions based on polyamide 12 or PA12, PA11, PA10.10, PA10.12 or PA12.12.

These polyamides are possessed of many advantageous properties. They are strong mechanically, with high low-temperature impact strength and high elongation at break. They are chemically resistant, especially to zinc chloride and to hydrolysis. They take up little moisture and are dimensionally stable. They are resistant to aging at high temperature in the presence of oxygen (thermooxidation). They are flexible and, what is more, they can easily be flexibilized by addition of plasticizer if the need arises.

These polyamides possess melting temperatures, termed Tm, of less than about 200° C. (measured by DSC in accordance with the standard ISO 11357).

Furthermore, the barrier polymers which are generally used to form the impermeable layer are fluoropolymers such as functionalized polyvinylidene fluoride (PVDF), semi-aromatic polyamides such as PA9.T, PA10.T/6.T, PAMXD.6, or other polymers such as ethylene-vinyl alcohol copolymer (EVOH), polyphenylene sulfide (PPS), or functionalized polybutylene naphthalate (PBN).

In the field of transport and of the automobile, there is presently an increase in the temperatures beneath the engine hood. Engines are operating at higher temperatures and are more confined. Moreover, for reasons of weight advantage, consideration is being given to replacing the metal or rubber piping, operating at high temperature, with polymeric piping, The under-hood temperatures are increasing to the point of exceeding with more and more frequency the melting temperature (Tm) of the polymer constituting the outer layer, and especially of the high-carbon-content flexible polyamide layer. It is therefore necessary to find an alternative to the metal or rubber piping, but this alternative must retain the essential qualities of the flexible, high-carbon-content, aliphatic polyamides that are in general use. The qualities required are, in particular, flexibility, chemical resistance, low water uptake, low-temperature impact, high elongation at break, resistance to aging in air and hot fluids, and, lastly, the ability to be employed at temperatures which are not excessively high.

Low-carbon-content aliphatic polyamides, such as PA6, PA6.6, PA4.6 are well known. They have melting temperatures Tm which are much greater than those of the high-carbon-content flexible polyamides, typically of 220° C. to 300° C. However, they lack chemical resistance, more particularly to zinc chloride. They are also very much inferior in terms of water uptake, low-temperature impact, and aging, even when allied with flexible polymers, such as impact modifiers. These low-carbon-content, aliphatic polyamides are therefore not a solution to this problem.

The semi-aromatic polyamides for their part, such as PA6.T/6.1, PA6.T/6.I/6.6, PA4.T/6.T/6.6 and PAMXD.6, have much higher melting temperatures Tm, typically of 240° C. to 340° C. However, they are particularly rigid and their elongation at break is low, even allied with flexible polymers, such as impact modifiers. As for the other properties, they are also inferior to the high-carbon-content, aliphatic polyamides. These polyamides are unable to represent an acceptable alternative.

Polyamides which have appeared more recently are the high-carbon-content, semi-aromatic polyamides, such as PA9.T, PA9.T/9′.T (where 9′ denotes a subunit obtained from 2-methyl-1,8-nonanediamine, an isomer of nonanediamine), PA 10.T/6.T, and PA10.T. They possess melting temperatures Tm which are much higher than the high-carbon-content, aliphatic polyamides, typically of 260° C. to 320° C. They exhibit high performance in chemical resistance and water uptake, but remain very rigid. It is virtually impossible to flexibilize them by incorporating plasticizer. Another drawback is that they require very high processing temperatures, typically of around 300-340° C. In the context of multilayer structures, this means raising the local temperature of the other polymers, which may give rise to degradation in said latter polymers, if the imposed temperature approaches or exceeds their degradation temperature. These polyamides are unable to be an acceptable solution.

Document EP 1 864 796 describes the use of a multilayer structure comprising at least two layers based on high-carbon-content semi-aromatic polyamide of type 9.T with the presence in the outer layer of a higher level of impact modifier than in the inner layer. This solves the problem of the inadequate impact resistance, but does not touch the problem of the low elongation at break, of the rigidity, which is still large, of the impossibility of flexibilizing the outer layer by the presence of a plasticizer, or of the mediocre aging resistance. The problem addressed is therefore not solved.

A description is found in documents EP 1 470 910, EP 1 245 657 and WO 2006/056581, of multilayer structures which are based on polyamide and on fluoropolymer, but which have inadequate performance properties (see structures 20, 21, 22 and 24 in the examples).

The technical problem addressed is therefore that of providing a multilayer structure which has the following collective features, namely a resistance at a high temperature of at least 200° C., good mechanical properties (especially flexibility, elongation at break, resistance to impacts at low temperatures) and good chemical properties (especially resistance to ZnCl₂ and good barrier properties with respect to the fluid stored or carried), while exhibiting very slow aging of the structure over time.

To solve the problem addressed, a specific multilayer structure has been found which combines, as an outer layer, a composition based on a specific copolyamide defined by very specific proportions of semi-aromatic units and of aliphatic units and, as inner layer, a barrier layer based on specific fluoropolymer.

The present invention accordingly aims to solve the technical problem addressed by means of a multilayer structure comprising:
a layer (L1)—outer layer—composed of a composition comprising predominantly one or more semicrystalline copolyamides (H) having a melting temperature of at least 220° C. and comprising at least 80 mol % of the two following units (s) and (a):
where unit (s) denotes one or more semi-aromatic units (s) formed
of one or more subunits obtained from aromatic diacid (sr) and
of one or more subunits obtained from aliphatic diamine (sa), the aliphatic diamine (sa) comprising from 9 to 13 carbon atoms,
where the unit (a) denotes one or more aliphatic units comprising 8 to 13 carbon atoms per nitrogen atom, and,

where the molar ratio (s)/(a) is from 1 to 3, and
a layer (L2) composed of a composition comprising predominantly one or more tetrafluoroethylene (TFE) copolymers, said TFE copolymer being mandatorily functionalized when the layer (L2) is in contact with the layer (L) or in contact with an interlayer comprising predominantly one or more polyamides.

The invention also relates to a pipe comprising the structure as defined above.

The invention also relates to the use of said structure, especially when it takes the form of a pipe, for the transport of polar and/or apolar fluids, especially those present in vehicles.

Other subjects, aspects, and features of the invention will become apparent from a reading of the description which follows.

In the present description, in the absence of any indication otherwise, all of the percentages (%) are molar percentages.

Moreover, any range of values, denoted by the expression “between a and b” represents the domain of values from more than a to less than b (in other words with end points a and b excluded), whereas any range of values denoted by the expression “from a to b” signifies the domain of values from a up to b (in other words, including the strict end points a and b).

The symbol “//” delimits the layers of a multilayer structure. The symbol “/” delimits the units of a copolymer.

A unit in the sense of the present invention means a linked chain of polyamide structure obtained from the polycondensation of lactam, amino acid or diamine and diacid.

Outer Layer (L1)

The multilayer structure according to the present invention comprises as its outer layer, a layer (L1) composed of a composition comprising predominantly one or more semicrystalline copolyamides (H).

Predominantly in the sense of the present invention means that the semicrystalline copolyamide or copolyamides (H) are present in the layer (L1) in an amount of more than 50 wt % relative to the total weight of the composition forming the layer (L).

According to one preferred embodiment of the invention, this layer (L1) is intended to be in contact with the air.

Semicrystalline Copolyamide (H)

A semicrystalline polymer, in the sense of the present invention, is a polymer which retains a solid state beyond its glass transition temperature (Tg).

The structure of the semicrystalline copolyamide (H) according to the present invention is as follows. It comprises at least 80 mol % of the two following units (s) and (a):
unit (s) denoting one or more semi-aromatic units (s) formed
of one or more subunits obtained from aromatic diacid (sr) and
of one or more subunits obtained from aliphatic diamine (sa), the aliphatic diamine (sa) comprising from 9 to 13 carbon atoms,
unit (a) denoting one or more aliphatic units comprising from 8 to 13 carbon atoms per nitrogen atom, and

the molar ratio (s)/(a) being from 1 to 3.

Moreover, semicrystalline copolyamide (H) has a melting temperature (Tm) of at least 220° C.

Semi-Aromatic Unit (s)

Generally speaking, in organic chemistry, an aliphatic compound is a saturated or unsaturated, cyclic or non-cyclic carbon-containing compound, with the exception of aromatic compounds. According to the present invention, though, the term “aliphatic” denotes a saturated or unsaturated, noncyclic, carbon-containing compound with the exception of cyclic compounds and of aromatic compounds. Accordingly, the term “aliphatic” covers only saturated or unsaturated, linear or branched, carbon-containing compounds.

The semi-aromatic unit (s) is formed of one or more subunits obtained from aromatic diacid (sr) and of one or more subunits obtained from aliphatic diamine (sa), the aliphatic diamine comprising from 9 to 13 carbon atoms.

The subunit obtained from the aliphatic diamine (sa) advantageously comprises from 10 to 13 carbon atoms.

The aromatic diacid may be selected from terephthalic acid, identified as T, isophthalic acid, identified as I, naphthalenic acid, and mixtures thereof.

The aliphatic diamine (identified as Ca, where Ca denotes the number of carbon atoms in the diamine) may be selected from nonanediamine (a=9), 2-methyl-1,8-nonanediamine (a=9′), decanediamine (a=10), undecanediamine (a=11), dodecanediamine (a=12), and tridecanediamine (a=13).

Examples of semi-aromatic units (s) according to the invention include the units 9.T, 9′.T (where 9′ originates from 2-methyl-1,8-nonanediamine), 10.T and combinations thereof such as, for example, 9.T/9′.T. The unit 10.T is used with preference.

The semi-aromatic units based on terephthalic acid (T) are particularly advantageous since they lead to polyamides with a high degree of crystallinity which give high melting temperatures. Preference will therefore be given to selecting semi-aromatic polyamides which are rich in terephthalic acid (T)-based unit, leading to a high degree of crystallinity and a high melting temperature. The subunit (sr) is preferably obtained only from terephthalic acid.

The proportion of semi-aromatic units (s) is preferably from 40 mol % to 75 mol %.

Aliphatic Unit (a)

The aliphatic unit (a) comprises from 8 to 13 carbon atoms per nitrogen atom. It advantageously comprises from 9 to 13 carbon atoms per nitrogen atom.

In the case of a unit of type X. Y, the number of carbon atoms per nitrogen atom is the molar average of the subunit X and of the subunit Y.

In the case of copolyamides, the number of carbon atoms per nitrogen atom is calculated according to the same principle. The calculation is made on a molar pro rata basis from the various amide units.

Accordingly, the selection of the lactams, amino acids, diamines and diacids must be made in dependence on this range of carbon atoms per nitrogen atom.

When the aliphatic unit (a) originates from the polycondensation of a lactam, this lactam may be selected from caprylolactam, enantholactam, pelargolactam, decanolactam, undecanolactam, and laurolactam.

When the unit (a) originates from the polycondensation of an amino acid, it may be selected from 9-aminononanoic acid, 10-aminodecanoic acid, 12-aminododecanoic acid, and 11-aminoundecanoic acid and also derivatives thereof, especially N-heptyl-11-aminoundecanoic acid.

When the unit (a) originates from the polycondensation of a diamine (identified as Ca, where Ca denotes the number of carbon atoms in the diamine) and of a Cb diacid (identified as Cb, where Cb denotes the number of carbon atoms in the diacid), the aliphatic diamine may be selected from butanediamine (a=4), pentanediamine (a=5), hexanediamine (a=6), heptanediamine (a=7), octanediamine (a=8), nonanediamine (a=9), 2-methyl-1,8-nonanediamine (a=9′), decanediamine (a=10), undecanediamine (a=11), dodecanediamine (a=12), tridecanediamine (a=13), tetradecanediamine (a=14), hexadecanediamine (a=16), octadecanediamine (a=18), octadecenediamine (a=18), eicosanediamine (a=20), docosanediamine (a=22), and diamines obtained from fatty acids.

The diamine Ca is advantageously selected from octanediamine (a=8), nonanediamine (a=9), 2-methyl-1,8-nonanediamine (a=9′), decanediamine (a=10), undecanediamine (a=11), dodecanediamine (a=12), and tridecanediamine (a=13).

The aliphatic diacid in turn may be selected from succinic acid (b=4), pentanedioic acid (b=5), adipic acid (b=6), heptanedioic acid (b=7), octanedioic acid (b=8), azelaic acid (b=9), sebacic acid (b=10), undecanedioic acid (b=11), dodecanedioic acid (b=12) and brassylic acid (b=13), tetradecanedioic acid (b=14), hexadecanedioic acid (b=16), octadecanoic acid (b=18), octadecenoic acid (b=18), eicosanedioic acid (b=20), docosanedioic acid (b=22), and the dimers of fatty acids containing 36 carbons.

The diacid Cb is advantageously selected from octanedioic acid (b=8), azelaic acid (b=9), sebacic acid (b=10), undecanedioic acid (b=11), dodecanedioic acid (b=12), and brassylic acid (b=13).

The abovementioned dimers of fatty acids are dimerized fatty acids obtained by oligomerization or polymerization of unsaturated monobasic fatty acids with a long hydrocarbon chain (such as linoleic acid and oleic acid), as described especially in document EP 0 471 566.

The diamine is preferably selected from nonanediamine (a=9), 2-methyl-1,8-nonanediamine (a=9′), decanediamine (a=10), undecanediamine (a=11), dodecanediamine (a=12), and tridecanediamine (a=13), and the diacid is selected from azelaic acid (b=9), sebacic acid (b=10), undecanedioic acid (b=11), dodecanedioic acid (b=12), and brassylic acid (b=13).

The aliphatic unit (a) is preferably linear.

The aliphatic unit (a) may be selected from 12, 11, 10.10, 10.12, 12.12, 6.14, and 6.12 units.

The units 12, 10.10, 10.12 and 12.12 are used with preference.

The proportion of aliphatic units (a) is preferably from 20 mol % to 50 mol %.

Ratio (s)/(a)

According to the present invention, the molar ratio (s)/(a) of the semi-aromatic units (s) to the aliphatic units (a) is from 1 to 3 and, preferably from 1.5 and 2.5.

Melting Temperature

The semicrystalline copolyamide (H) according to the invention has a melting temperature (Tm) of at least 220° C., preferably of from 220 to 320° C., more particularly from 220 to 280° C.

It has been observed that, below 220° C., the crystallinity and the tensile strength are not acceptable.

The melting temperature is measured by DSC (Differential Scanning Calorimetry) in accordance with the standard ISO 11357.

Melting Enthalpy

The melting enthalpy, measured by DSC in accordance with the standard ISO 11357, of the semicrystalline copolyamide (H) according to the invention is preferably greater than or equal to 10 J/g, more preferably greater than or equal to 25 J/g. Thus, the copolyamide is subjected to first heating of 20° C./min to a temperature of 340° C., then to a cooling at 20° C./min to a temperature of 20° C., then to second heating at 20° C./min to a temperature of 340° C., with the melting enthalpy being measured during this second heading.

The semicrystalline copolyamide (H) according to the present invention comprises at least 80 mol % and, preferably at least 90 mol %, of the two units (s) and (a) as defined above. Accordingly, it may comprise other units with a structure different from those of the units (s) and (a).

Other Unit

Accordingly, the semicrystalline copolyamide (H) according to the present invention may comprise from 0 to 20% of one or more units other than the aforesaid aliphatic units (a) and semi-aromatic units (s). The following units may be contemplated, but without limitation.

The semicrystalline copolyamide (H) according to the present invention may comprise one or more semi-aromatic units formed of a subunit obtained from aromatic diacid and of a subunit obtained from diamine, this diamine having a number of carbon atoms of from 4 to 8 or else greater than or equal to 14.

The semicrystalline copolyamide (H) according to the present invention may also comprise one or more aliphatic units in which the number of carbon atoms per nitrogen atom is from 4 to 7 or else is greater than or equal to 14.

Cycloaliphatic units originating from the polycondensation of diamines and diacids, with one of these two compounds being cycloaliphatic, may also be provided.

When the diamine is cycloaliphatic, it is selected from bis(3,5-dialkyl-4-aminocyclohexyl)methane, bis(3,5-dialkyl-4-aminocyclo-hexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM), p-bis(aminocyclohexyl)methane (PACM), and isopropylidenedi(cyclohexylamine) (PACP). It may also comprise the following carbon skeletons: norbornylmethane, cyclohexylmethane, dicyclohexylpropane, di(methylcyclohexyl), or di(methylcyclohexyl)-propane. A non-exhaustive list of these cycloaliphatic diamines is given in the publication “Cycloaliphatic Amines” (Encyclopaedia of Chemical Technology, Kirk-Othmer, 4th edition (1992), pp. 386-405).

In this case, the diacid may be aliphatic, linear or branched, as defined above, or else cycloaliphatic or aromatic.

When the diacid is cycloaliphatic, it may comprise the following carbon skeletons: norbornylmethane, cyclohexylmethane, dicyclohexylmethane, dicyclohexylpropane, di(methylcyclohexyl), or di(methylcyclohexyl)propane.

In this case, the diamine may be aliphatic, linear or branched, as defined above, or else cycloaliphatic or aromatic.

The copolyamide (H) according to the invention is preferably composed of the following units:
from 40 mol % to 75 mol % of one or more semi-aromatic units (s),
from 20 mol % to 50 mol % of one or more aliphatic units (a), and
from 0 to 20 mol % of one or more units other than the aforesaid units (a) and (s).

The copolyamide (H) according to the invention preferably comprises no units other than the aliphatic units (a) and the semi-aromatic units (s). It is accordingly composed of:
from 50 mol % to 75 mol % of one or more semi-aromatic units (s), and
from 25 mol % to 50 mol % of one or more aliphatic units (a)

The semicrystalline copolyamide (H) is preferably selected from PA12/9.T, PA6.12/10.T, PA10.10/10.T, PA10.10/10.T/6.T, PA10.10/10.T/10.I, and PA10.12/10.T.

Amine Chain Termination

The semicrystalline copolyamide (H) according to the invention preferably has an amine chain end content of greater than or equal to 40 μeq/g. This amine chain end content ranges advantageously from 42 μeq/g to 100 μeq/g and preferably from 45 μeq/g to 70 μeq/g.

The amine-function chain end content is measured in a conventional way known to the skilled person, by potentiometry.

The composition may also be formed predominantly of a mixture of two or more aforementioned copolyamides (H).

Like any polymeric material, the composition of the outer layer (L1) of the multilayer structure may further comprise one or more polymers and/or one or more additives.

Accordingly, the composition of the outer layer (L1) may comprise one or more supplementary polymers. This or these supplementary polymer or polymers may be selected, for example, from aliphatic polyamides comprising preferably more than 9 carbon atoms per nitrogen, functionalized or nonfunctionalized polyolefins and a mixture thereof.

In the context of impact modifiers, the supplementary polymer may be a functionalized copolyolefin comprising one or more anhydride or acid functions, optionally in a mixture with at least one polymer comprising one or more epoxide functions.

The composition forming the outer layer (L1) advantageously comprises at least 18 wt % of one or more supplementary polymers such as one or more impact modifiers, at least one of which is anhydride functionalized, the impact modifier or modifiers being preferably of copolyolefin type with a Tg of less than −10° C. and an ISO 178 flexural modulus of less than 100 MPa.

The composition forming the outer layer (L1) preferably comprises at least 30 wt % of two or more supplementary polymers relative to the total weight of the composition, these supplementary polymers forming a crosslinked elastomeric phase. This crosslinked elastomeric phase is composed of at least one acid- or anhydride-functionalized impact modifier, of at least one polymer or a molecule possessing a plurality of epoxide functions and, optionally, of at least one polymer or a molecule possessing a plurality of acid functions, all of these polymers being preferably of copolyolefin type with a Tg of less than −10° C. and an ISO178 flexural modulus of less than 100 MPa.

The composition forming the outer layer (L) may also comprise additives. The possible additives include stabilizers, dyes, plasticizers, fillers, fibers, surfactants, pigments, fluorescent whiteners, antioxidants, natural waxes, and mixtures thereof.

For the plasticizers, an amount of up to 15 wt % of the total weight of the composition may be introduced.

Barrier layer (L2)

In the structure according to the invention the barrier layer (L2) is an inner layer, or even the innermost layer, in other words the layer intended preferably to be in contact with the fluids.

When the structure comprises more than two layers, the layer may therefore be an interlayer or else may constitute the innermost layer. It is also possible to contemplate having a plurality of barrier layers with the aim of complementarity or of performance of the structure. The barrier layer predominantly comprises a barrier material, this being a material which is much more impermeable to the fluids than are the high-carbon-content aliphatic polyamides conventionally used as outer layer. The fluids used are especially gasolines, alcohols, cooling liquids, refrigerant fluids, or else urea solutions. The materials may be classified according to their permeability to CE10 alcoholized gasoline (45% isooctane+45% toluene+10% ethanol) at 60° C. It may be considered, for example, that a material is able to constitute a barrier layer, if it is at least 5 times less permeable than PA-12.

The barrier layer (L2) present in the structure according to the invention is composed of a composition comprising predominantly one or more tetrafluoroethylene (TFE) copolymers, the TFE copolymer being mandatorily functionalized when the layer (L2) is in contact with the layer (L1) or in contact with an interlayer comprising predominantly one or more polyamides. By “predominantly” in the sense of the present invention is meant that the polyamide or polyamides are present in the interlayer in an amount of more than 50 wt %, relative to the total weight of the composition forming this interlayer.

The TFE copolymer is advantageously a copolymer in which the molar proportion of the TFE unit is predominant relative to the proportion of the other unit or units forming said copolymer. These other units may especially be obtained from ethylene, from chlorotrifluoroethylene, from hexafluoropropylene or from a perfluoroalkyl vinyl ether, such as perfluoropropyl vinyl ether.

The TFE copolymer is advantageously selected from ethylene-tetrafluoroethylene copolymer (ETFE), tetrafluoroethylene-chlorotrifluoroethylene copolymer (CTFE) and a mixture thereof. When it is functionalized, this TFE copolymer comprises one or more anhydride, epoxy, acid or else acid halide functions.

When the layer (L2) is in contact with the layer (L1) or in contact with an interlayer comprising predominantly one or more polyamides, the tetrafluoroethylene copolymer is mandatorily functionalized. As indicated above, it may be functionalized by anhydride, epoxy, or acid functions or else acid halide functions. The functions borne by the TFE copolymer will react with the (co)polyamide of the adjacent layer, in other words with the (co)polyamide in direct contact with the TFE copolymer of the layer (L2), and especially with the amine functions of the (co)polyamide, thereby ensuring the adhesion of these two layers to one another.

TFE copolymers of these kinds are especially available under the trade name Neoflon® EP7000 from Daikin or else Fluon® AH2000 from Asahi.

The composition may also be composed of a mixture of two or more TFE copolymers.

Less directly exposed to the heat of the engine environment than the outer layer (L1), the barrier layer (L2) may have a melting temperature of less than 220° C., since the upper layer or layers act as a thermal shield to the underlying layer or layers. However, the composition of the barrier layer will advantageously be selected with a melting temperature Tm of greater than 220° C., and more advantageously still will be selected with a Tm of from 220° C. to 280° C.

Like any polymeric material, the composition of the barrier layer (L2) of the structure may further comprise one or more other polymers and/or one or more additives. It is, however, predominantly composed of the aforementioned TFE barrier copolymer or copolymers.

The supplementary polymers to which consideration may be given may be selected especially from the supplementary polymers already referred to above as being able to form part of the composition of the outer layer (L1).

The possible additives include stabilizers, dyes, plasticizers, fillers, nanofillers and especially those with a character such as to reinforce the barrier, such as nanoclays.

The layer (L2) advantageously comprises conductive fillers such as carbon black, so as to make it antistatic.

Multilayer Structure

The outer layer (L1) made of semicrystalline copolyamide (H) according to the invention, and the barrier layer (L2), may, for example, simply be combined to form a two-layer pipe in the following way, with—from the outside to the inside:

copolyamide (H) layer (L1)//functionalized barrier layer (L2).

The structure may also comprise a plurality of layers with different and complementary characters.

Therefore, according to a second embodiment, the structure may be a three-layer structure comprising an interlayer (L3) arranged between the layers (L1) and (L2). Such a multilayer structure may comprise, from the outside to the inside, the following layers:

layer (L1)//layer (L3)//functionalized barrier layer (L2).

The interlayer (L3) may, for example, comprise one or more high-carbon-content aliphatic polyamides (in other words one or more aliphatic (co)polyamides comprising from 9 to 36 carbon atoms per nitrogen atom (for example PA11)).

The interlayer (L3) may also be a layer which also has barrier properties—for example, a layer comprising one or more polyphthalamides.

According to a third embodiment, when the layer (L2) is composed predominantly of one or more TFE polymers as defined above, which are functionalized, the structure may comprise a supplementary layer located in contact with said layer (L2) and forming the innermost layer of the structure; this supplementary layer may be a barrier layer.

The multilayer structure may comprise, from the outside to the inside, the following layers:

copolyamide (H) layer (L1)//functionalized barrier layer (L2)//optionally conductive barrier layer.

This supplementary layer may more particularly be a barrier layer and may comprise one or more fluoropolymers as defined above which are nonfunctionalized, and, optionally, conductive fillers.

The multilayer structure may in that case comprise from the outside to the inside, the following layers:

copolyamide (H) layer (L1)//functionalized barrier layer (L2)//optionally conductive nonfunctionalized barrier layer (L2).

According to a fourth embodiment, symmetrical multilayer structures may be produced, such as, for example, a three-layer structure with—from the outside to the inside:

copolyamide (H) layer (L1)//functionalized barrier layer (L2)//copolyamide (H) layer (L1).

According to a fifth embodiment, layers with new functions may be produced, such as, for example, with—from the outside to the inside:

copolyamide (H) layer (L1)//functionalized barrier layer (L2)//conductive aliphatic PA layer.

The aliphatic PA constitutes the inner layer, where the temperature is less high than on the outside, facing the environment of the engine.

In all of the multilayer structures described above, it is possible advantageously to add conductive fillers to the composition of the innermost layer in order to dissipate any electrostatic charges, especially when this innermost layer is formed of TFE copolymer.

One important aspect for the production of such multilayer structures is the adhesion of the layers to one another.

One way of producing effective adhesion is to use a polymer functionalized with a function which is reactive toward one of the chain ends of the copolyamide (H) in the robust layer (L1).

This is the case, for example, with the ETFE Fluon AH2000 from Asahi, which is a barrier polymer possessing an anhydride functionalization. The anhydride reacts with the amine chain ends of the copolyamide (H). It will therefore be appropriate to select a polyamide, especially a copolyamide (H), which is sufficiently rich in NH₂ amine chain ends to produce effective adhesion, typically having an amine chain ends content of greater than 40 μeq/g, as indicated above.

Another way of obtaining effective adhesion between the copolyamide layer (H) constituting the robust layer (L1) and the barrier polymer layer (L2) is to place a binder interlayer between them. The binder may be a mixture of the compositions of these two layers, advantageously accompanied by a certain amount of compatibilizer (refer, for example, to documents EP 1 162 061 and EP 2 098 580).

Preparation of the Compositions

The copolyamides (H) according to the invention are synthesized by customary techniques of polymerization, more particularly by polycondensation.

The compositions comprising the copolyamides (H) are fabricated by the usual techniques of compounding, more particularly on a twin-screw extruder in the melt state.

The multilayer structures are typically fabricated by co-extrusion of each layer in the melt state. The multilayer pipe is a specific representative of a multilayer structure.

Generally speaking, the production of a multilayer pipe requires the use of a plurality of extruders with their temperature controlled, which are selected and regulated so as to be compatible with the structure to be produced. These extruders converge on a distribution and stream-assembly block which is called a co-extrusion head and is temperature-controlled. The role of the co-extrusion head is to assemble the melted polymers from each of the extruders by optimizing their pathway so that the speed profile is as uniform as possible on exit from the tooling. The uniformity of the speed profiles is necessary for the regularity of the thickness profiles of each of the layers. This assembling of layers takes place by a melt method. When they have been assembled, the layers, still in the melt state, pass through a tooling set (punch/die) before being drawn while hot in the free air, then calibrated by means of a sizing die. Calibration is accompanied by cooling, since the sizing die is immersed in a water bath (5<T°<80° C.) or sprayed with water using nozzles. Calibration takes place usually under vacuum (20-500 mbar), in order to ensure the roundness of the pipe and better to control its dimensional characteristics. The pipe is cooled along a series of water baths. The pipe is drawn by a mechanical drawing assembly which imposes the drawing speed on the line (typically 10 to 80 m/min). Peripheral systems may be harnessed in order to meet specific needs (on-line control of thicknesses or of diameter, flame treatment, etc.). The skilled person knows how to regulate the parameters of the extruders and of the whole of the line to integrate pipe quality (diameter, distribution of thicknesses, mechanical or optical properties, etc.) and productivity requirements (stability of extrusion parameters over time, target throughputs, etc.).

The multilayer pipe optionally may be annealed, depending on the demands of the applications, requiring more or less flexibility or imposing geometric constraints to a greater or lesser extent. Annealing takes place using a punch/die tooling mounted upstream of the coextrusion head, then via the use of an annealing stand which allows the hot pipe to be shaped inside specific molds.

Multilayer structures of these kinds, especially taking the form of multilayer pipes, may also be produced in a plurality of steps, meaning that an outer layer may be added in the course of a second repeat step, by covering, via the use of a supplementary crosshead.

The scope of the invention would also encompass the addition to a multilayer structure as described above, in a second repeat step, of a supplementary layer arranged above the outer layer (L1), as for example an elastomer layer with the aim of offering supplementary protection, for example to friction, or in order to minimize any noise problems.

The scope of the invention would likewise encompass the addition of a braid to the inside of the multilayer structure, in order, for example, to increase the resistance to bursting under pressure.

The invention likewise provides a pipe comprising a structure as defined above.

The invention relates, lastly, to the use of the structure according to the invention, especially in the form of a pipe, for transporting or transferring polar and/or apolar fluids, especially those present in vehicles.

The fluid may be selected from an oil, a lubricant, a liquid based on urea solution, on ammonia, on aqueous ammonia, on petrol and compounds thereof, a fuel, especially an alcoholized fuel and more particularly a bio-gasoline, a hydraulic fluid, a refrigerant fluid or fluid refrigerant (such as CO₂ or a fluorocarbon fluid such as 1,1,1,2-tetrafluoroethane or else 2,3,3,3-tetrafluoropropene), a cooling liquid, more particularly a glycol-based cooling liquid, and also air, engine gas emanations, such as oil pan gases or combustion gases.

The multilayer structure according to the invention may advantageously be used for producing all or part of elements of industrial equipment for the storage, the transport or transfer of fluids such as those listed above. Such fluids may be hot or cold. Such equipment may be intended for use in the field of industry in general (for example, for pneumatic, hydraulic lines or steam cleaning lines) and also in the field of the exploitation of petroleum and gas deposits under the sea (offshore sector).

More particularly, and especially in the field of transport (automobiles, trucks, etc.), the multilayer structure according to the invention, when present for example in the form of pipes, may be used more particularly:
in a gas circulation device, under superatmospheric or subatmospheric pressure, such as an air admission device or ventilation device for engine gases, or a braking assistance device,
in an oil or lubricant circulation device, such as an oil cooling device, a hydraulic device or a braking device,
in a device for circulating aqueous or nonaqueous liquid, such as an engine cooling device or a selective catalytic reduction device,
in a device for circulating refrigerant fluid or fluid refrigerant, such as an air-conditioning circuit,
in a device for storing, transporting, or transferring (or circulating) fluids, more particularly fuels.

The examples which follow serve to illustrate the invention without, however, having any limiting character.

### 1/COMPONENTS

Copolyamides (H) of the Invention

These copolyamides are fabricated by customary techniques of polycondensation. An illustration of this will be found in patent U.S. Pat. No. 6,989,198, on pages 18 and 19. The symbol T denotes terephthalic acid, with I denoting isophthalic acid.

Copolyamide (A) is a PA10.10/10.T containing 41 mol % of 10.10 units and having an intrinsic viscosity of 1.21, a terminal NH₂ group content of 55 μeq/g, a melting temperature Tm of 260° C. and a melting enthalpy of 29 J/g.

Copolyamide (Ab) is a PA10.10/10.T containing 33 mol % of 10.10 units and having an intrinsic viscosity of 1.19, a terminal NH₂ group content of 58 μeq/g, a melting temperature Tm of 279° C. and a melting enthalpy of 38 J/g.

Copolyamide (Ac) is a PA10.10/10.T containing 23 mol % of 10.10 units and having an intrinsic viscosity of 1.12, a terminal NH₂ group content of 59 μeq/g, a melting temperature Tm of 298° C. and a melting enthalpy of 38 J/g.

Copolyamide (D) is a PA12/9.T containing 41 mol % of 12 units and having an intrinsic viscosity of 1.28, a terminal NH₂ group content of 49 μeq/g, a melting temperature Tm of 266° C. and a melting enthalpy of 30 J/g.

Copolyamide (E) is a PA10.10/10.T/6.T containing 25 mol % of 10.10 units, and 55 mol % of 10.T units and having an intrinsic viscosity of 1.09, a terminal NH₂ group content of 62 μeq/g, a melting temperature Tm of 283° C. and a melting enthalpy of 33 J/g.

Copolyamide (F) is a PA10.10/10.T/10.I containing 25 mol % of 10.10 units, and 55 mol % of 10.T units and having an intrinsic viscosity of 1.12, a terminal NH₂ group content of 59 μeq/g, a melting temperature Tm of 274° C. and a melting enthalpy of 29 J/g.

Other Components

Copolyamide (M) is a PA9.T/9′.T containing 50 mol % of 9′.T units and having an intrinsic viscosity of 1.15, a melting temperature Tm of 264° C. and a melting enthalpy of 30 J/g.

Copolyamide (P) is a PA6.T/6.I/6.6 containing 50 mol % of 6.T units, 40 mol % of 6.I units and 10 mol % of 6.6 units, having an intrinsic viscosity of 1.08, a melting temperature Tm of 267° C. and a melting enthalpy of 30 J/g.

Copolyamide (Q) is a PA6.T/6.I/6.6 containing 55 mol % of 6.T units, 20 mol % of 6.I units and 25 mol % of 6.6 units, having an intrinsic viscosity of 1.01, a melting temperature Tm of 301° C. and a melting enthalpy of 24 J/g.

The impact modifier (L) denotes a copolymer of ethylene, butyl acrylate and maleic anhydride, PE/BA/MAH having a weight BA content of 30%, a weight MAH content of 1.5% and an MFI of 1 at 235° C. under 5 kg.

The impact modifier (X) denotes a copolymer of ethylene, methyl acrylate and glycidyl methacrylate, PE/MA/GMA having a weight MA content of 30%, a weight GMA content of 5% and an MFI of 3 at 235° C. under 5 kg.

The impact modifier (EPRm) denotes an ethylene-propylene elastomer functionalized by a reactive anhydride group (at 0.5-1% by mass) having an MFI of 9 at 230° C., under 10 kg, of type Exxelor VA1801, from Exxon.

The impact modifier (mPE) denotes an ethylene-octene copolymer functionalized by a reactive anhydride group (at 0.5-1% by mass) having an MFI of 1.4 at 190° C., under 2.16 kg, of type Fusabond MN493D, from Dupont.

(StabCu) denotes a mixture of inorganic stabilizers based on copper iodide and potassium iodide, of type Iodide P201 from Ciba.

(Stab1) denotes a mixture of organic stabilizers composed of 80% of Lowinox 44B25 phenol from Great Lakes and of 20% of Irgafos 168 phosphite from Ciba.

(BBSA) denotes the plasticizer butylbenzylsulfonamide.

Polyamide (PA 10.10) denotes a homopolyamide PA10.10 with an intrinsic viscosity of 1.65.

Polyamide (PA12a) denotes a polyamide PA12 with an intrinsic viscosity of 1.3 and a terminal NH₂ group content of 70 μeq/g.

Polyamide (PA12b) denotes a polyamide PA12 with an intrinsic viscosity of 1.6 and a terminal NH₂ group content of 45 μeq/g.

Polyamide (PA6) denotes a polyamide PA6 with an intrinsic viscosity of 1.55 and a terminal NH₂ group content of 53 μeq/g.

The intrinsic viscosity (sometimes abbreviated to visco inh) is measured by means of an UBBELHODE viscosimeter at 25° C. in meta-cresol for 0.5 g of polymer in 100 ml of meta-cresol. This principle is described in Ullmann's Encyclopedia of Industrial Chemistry—Vol. A 20, pp. 527-528 (1995—5th edition).

The terminal NH₂ group content is measured by potentiometry.

### 2/COMPOSITIONS

Copolyamide compositions are fabricated by compounding on a twin-screw extruder in the melt state. We used a Werner 40 twin-screw, with a screw speed of 300 revolutions/minute, a throughput of 70 kg/h, a temperature of 300° C. for the compositions with ingredients that have a melting point of less than 285° C. or a temperature of 320° C. for those in which the ingredients have a melting point of from 285° C. to 310° C.

(A1) denotes a composition comprising 20% of impact modifier (L), 10% of impact modifier (X), 0.5% of (StabCu), the remainder to 100% being copolyamide (A).

(A2) denotes a composition comprising 20% of impact modifier (L), 10% of impact modifier (X), 5% of plasticizer (BBSA), 0.5% of (StabCu), the remainder to 100% being copolyamide (A).

(A3) denotes a composition comprising 12% of impact modifier (L), 0.5% of (StabCu), the remainder to 100% being copolyamide (A).

(A4) denotes a composition comprising 20% of impact modifier (EPRm), 0.5% of (StabCu), the remainder to 100% being copolyamide (A).

(A5) denotes a composition comprising 30% of impact modifier (mPE), 0.5% of (StabCu), the remainder to 100% being copolyamide (A).
(Ab1) denotes a composition identical to composition (A1) except that the copolyamide is copolyamide (Ab).

(Ac1) denotes a composition identical to composition (A1) except that the copolyamide is copolyamide (Ac).

(Ac10) denotes a composition comprising 20% of impact modifier (L), 10% of impact modifier (X), 15% of (PA10.10), 0.5% of (StabCu), the remainder to 100% being copolyamide (Ac).

(D1) denotes a composition comprising 20% of impact modifier (L), 10% of impact modifier (X), 0.5% of (StabCu), the remainder to 100% being copolyamide (D).

(E1) denotes a composition comprising 20% of impact modifier (L), 10% of impact modifier (X), 0.5% of (StabCu), the remainder to 100% being copolyamide (E).

(F1) denotes a composition comprising 20% of impact modifier (L), 10% of impact modifier (X), 0.5% of (StabCu), the remainder to 100% being copolyamide (F).
(M1) denotes a composition comprising 15% of impact modifier (EPRm), 1% of (Stab1), the remainder to 100% being copolyamide (M).

(P1) denotes a composition comprising 15% of impact modifier (EPRm), 1% of (Stab1), the remainder to 100% being the copolyamide (P).

(Q1) denotes a composition comprising 20% of impact modifier (L), 10% of impact modifier (X), 0.5% of (StabCu), the remainder to 100% being the copolyamide (Q).

(PA12h) denotes a composition comprising 20% of impact modifier (L), 10% of impact modifier (X), 0.5% of (StabCu), the remainder to 100% being (PA12a).

(PA12hip) denotes a composition comprising 6% of impact modifier (EPRm), 6% of (BBSA), 1% of (Stab1), the remainder to 100% being (PA12b).

(PA6hip) denotes a composition comprising 6% of impact modifier (EPRm), 12% of (BBSA), 1% of (Stab1), the remainder to 100% being (PA6).

Compositions of the Barrier Layers (L2) of the Invention

The following compositions are commercial products.

(ETFE-1) is an ETFE (denoting a copolymer of ethylene (E) and of tetrafluoroethylene (TFE)) which is functionalized, has the name Neoflon EP7000 and is produced by Daikin. It is functionalized by reactive groups which will react with the chain ends of the polyamides. A product of this kind is described in document U.S. Pat. No. 6,740,375.

(ETFE-2) is an ETFE which is anhydride-functionalized, has the name Fluon® AH2000 and is produced by Asahi. It is functionalized by reactive anhydride groups which will react with the chain ends of the polyamides. A product of this kind is described in document U.S. Pat. No. 6,740,375.

(Fluoro-3) is a TFE copolymer which is functionalized, has the name Neoflon® CPT LP-1030 and is produced by Daikin. It is functionalized by reactive groups which will react with the chain ends of the polyamides. This TFE copolymer is composed predominantly of TFE and also of CTFE (chlorotrifluoroethylene) and PPVE (perfluoropropyl vinyl ether). Products of this kind are described in document EP 2 264 086.

(ETFE-cond) is a carbon black-filled ETFE composition which has the name Neoflon ET610AS and is produced by Daikin. The carbon black endows this composition with antistatic properties.

Compositions of the Comparative Barrier Layers

(PVDF-1) is a PVDF (polyvinylidene fluoride) which is functionalized by 0.5% of maleic anhydride and has an MFI of 2 at 230° C. under 5 kg.

### 3/MULTILAYER STRUCTURES

The multilayer structures prepared are multilayer pipes with a diameter of 8 mm and a thickness of 1 mm which were produced by coextrusion. This necessitates the use of a plurality of temperature-controlled extruders, selected and regulated in such a way that they are compatible with the structure to be produced. This especially involves temperature-controlling an extruder in such a way as to be sufficiently above the melting temperature of the polymer in the composition. With regard to the coextrusion, reference is made to that which has been described above.

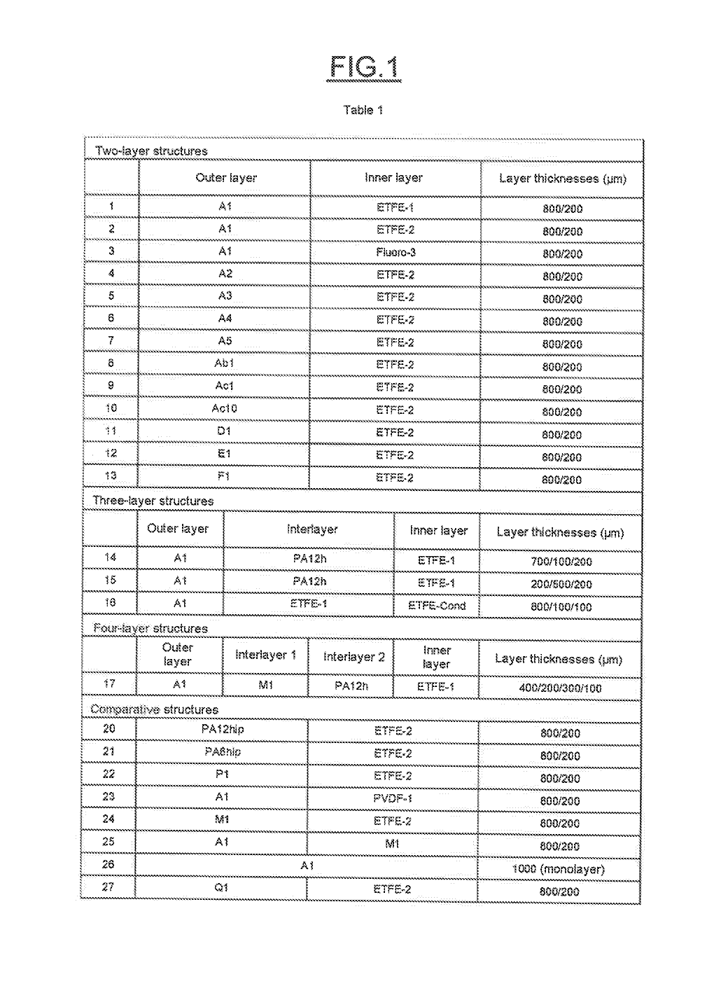

We produce the structures which appear in table 1 (see FIG. 1).

### 4/EVALUATION OF THE MULTILAYER STRUCTURES

These structures are subsequently evaluated according to various criteria, which are described below.

Thermomechanical Behavior at 200° C. (Abbreviated to: Behavior at 200° C.)

This test allows us to estimate the service temperature.

The pipe is placed in an oven at 200° C. for 30 minutes. Its condition is then observed:
“Pass” signifies that the pipe has retained its physical integrity, that it has not undergone significant deformation and that it has not melted.
“Melted” signifies that the pipe has undergone significant deformation and that it has, in part at least, melted.

Flexibility

This is the flexural modulus as measured in accordance with standard ISO178, after conditioning at 23° C. under 50% relative humidity for 15 days.

The assessment criteria are as follows:
B=good if <900 MPa
AB=acceptable between 900 and 1500 MPa
Mv=poor if >1500 MPa.

Elongation at Break (Abbreviated to: Elongation) This corresponds to the elongation at break in accordance with standard ISO527, after conditioning at 23° C. under 50% relative humidity for 15 days.

The assessment criteria are as follows:
good if >100%
poor if <50%

Zinc chloride resistance (abbreviated to: ZnCl₂)

This resistance is tested on the parts exposed to the actions of road salts, in other words, on the outer face of the pipe and the connection side, corresponding to the location at which the pipe is cut.

The zinc chloride resistance is measured in accordance with the standard SAE J2260. The pipes, bent beforehand with a radius of curvature of 40 mm, are immersed in a 50% ZnCl₂ solution. A record is made of the time after which cracks or the first breakage occurs.

The assessment criteria are as follows:
“Pass”=satisfactory, corresponding to a time>=800 h
“Breaks”=poor, corresponding to a time<=100 h

VW Cold Impact −40° C. (Abbreviated to: −40° C. Impact)

This is an impact test according to the VW protocol (Volkswagen) in accordance with the standard TL 52435. According to this test protocol, the pipe is subjected to impact at −40° C. The percentage breakage is taken.

The assessment criteria are as follows:
TB=very good, if 0% breakage
B=good, if <25% breakage
AB=fairly good, if between 25 and 50% breakage
Mv=poor, if >50% breakage

Adhesion

This involves measuring the adhesive force between the layers, expressed in N/cm. It is conveyed by measuring the peel strength, expressed in N/cm, and measured on the pipe with an 8 mm diameter and a thickness of 1 mm that has undergone conditioning at 50% relative humidity and 23° C. for 15 days.

In the case of a pipe with 3 layers or more, the value given relates to the weakest interface, in other words that having the least good adhesion, at the point where the greatest risk of delamination is. Peeling of the interface is performed by subjecting one of the parts to pulling at an angle of 900 and a rate of 50 mm/min in accordance with the following process.

A strip of pipe with a width of 9 mm is removed by cutting. This strip is therefore in the form of a sheet and still possesses all of the layers of the original pipe. The separation of the two layers of the interface it is desired to evaluate is initiated by means of a knife. Each of the layers thus separated is placed in the jaws of a tensile machine. Peeling is carried out by exerting traction on these 2 layers from either side at 1800 and at a rate of 50 mm/min. The strip, and therefore the interface, is itself held at 90 degrees relative to the direction of traction.

The assessment criteria take account of this and are as follows:
B=good, if >40 N/cm
Acc=fairly good (acceptable), between 40 and 20 N/cm
Mv=mediocre to poor, if <20 N/cm

Thermal Aging Resistance (Abbreviated to: Aging)

This relates to the resistance of the multilayer pipe to oxidative aging in hot air. The pipe is aged in air at 150° C. Regular samples are taken throughout the time. The pipes thus sampled are then subjected to impact in accordance with the standard DIN 73378, this impact being carried out at −40° C., and an indication is given of the half-life (in hours) corresponding to the time after which 50% of the pipes tested undergo breakage.

Cooling Liquid Aging Resistance (Abbreviated to: Age LLC)

This is the aging resistance of the multilayer pipe when it is filled with cooling liquid on the inside and exposed to air on the outside. Air and cooling liquid are at 130° C. The cooling liquid is a 50/50 by mass water/glycol mixture. The pipe is aged under these conditions for 1500 hours. The pipes are then subjected to impact in accordance with the standard DIN 73378, this impact being performed at −40° C.; the percentage of broken pipe is reported.

Cooling Liquid Permeability (Abbreviated to: Barrier)

The quality of the barrier with respect to the cooling liquid is estimated by measuring the permeability during the preceding aging test. The permeability is the loss of liquid, and is expressed in g/m2/24 h/mm.

Urea Solution Aging Resistance (Abbreviated to: Urea Aging)

The pipes are immersed in a 32.5% urea solution and undergo a number of cycles. One cycle lasts 24 hours and consists of 23 and a half hours at 70° C. and half an hour at 170° C. The elongation at break is the criterion of evaluation. The half-life is reached when the elongation has attained 50% of the initial value. The half-life is expressed in hours.

### 5/RESULTS

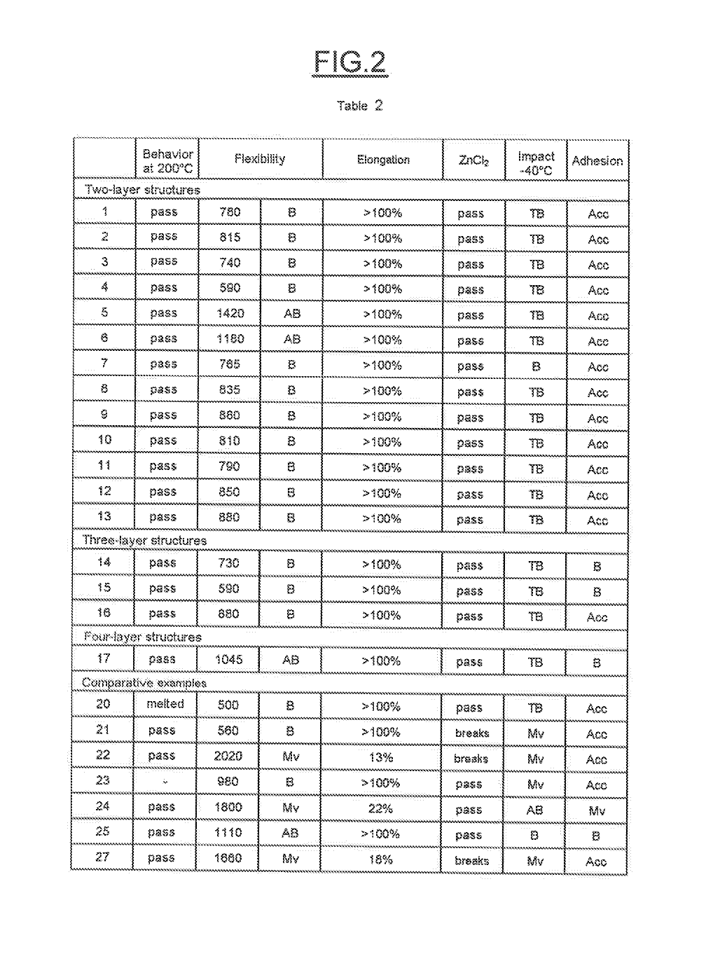

The test results appear in table 2 (see FIG. 2) and in tables 3 and 4 below.

Table 3 below contains the results of the tests evaluating the aging of the structures.

TABLE 3

| | | Aging | Urea aging |
|---|---|---|---|
| Structures | | (hours) | (hours) |
| According to | 1 | 2900 | >1000 |
| the invention | | | |
| Comparative | 21 | 50 | <480 |
| | 22 | 100 | <480 |
| | 23 | 330 | <480 |

Table 4 below contains the results of the tests comparing a comparative monolayer structure and two structures according to the invention.

TABLE 4

| | | LLC aging | Barrier |
|---|---|---|---|
| Structures | | (%) | (g/m²/24 h/mm) |
| According to the | 1 | 30 | 130 |
| invention | 3 | 0 | 50 |
| Comparative | 26 | 90 | 310 |

### 5/CONCLUSIONS

The results show that the structures according to the invention lead to improved properties, in terms of thermomechanical resistance, ZnCl₂ resistance, flexibility, impact resistance, aging, and barrier properties.

1. A multilayer structure comprising:
a layer (L1)—outer layer—composed of a composition comprising predominantly one or more semicrystalline copolyamides (H) having a melting temperature of at least 220° C. and comprising at least 80 mol % of the two following units (s) and (a):
where unit (s) denotes one or more semi-aromatic units (s) formed
of one or more subunits obtained from aromatic diacid (sr) and
of one or more subunits obtained from aliphatic diamine (sa), the aliphatic diamine (sa) comprising from 9 to 13 carbon atoms,
where the unit (a) denotes one or more aliphatic units comprising 8 to 13 carbon atoms per nitrogen atom, and
where the molar ratio (s)/(a) is from 1 to 3, and
a layer (L2) composed of a composition comprising predominantly one or more tetrafluoroethylene (TFE) copolymers, said TFE copolymer being mandatorily functionalized when the layer (L2) is in contact with the layer (L1) or in contact with an interlayer comprising predominantly one or more polyamides.

2. The structure as claimed in claim 1, characterized in that the tetrafluoroethylene copolymer or copolymers are selected from ethylene-tetrafluoroethylene copolymer (ETFE), tetrafluoroethylene-chlorotrifluoroethylene copolymer (CTFE), and a mixture thereof, which are optionally functionalized by anhydride, epoxy, acid or else acid halide functions.

3. The structure as claimed in claim 1 or 2, characterized in that the melting enthalpy of the semicrystalline copolyamide (H) is greater than or equal to 10 J/g, preferably greater than or equal to 25 J/g.

4. The structure as claimed in any one of claims 1 to 3, characterized in that the melting temperature of the semicrystalline copolyamide (H) is from 220° C. to 280° C.

5. The structure as claimed in any one of claims 1 to 4, characterized in that the copolyamide (H) is composed:
of 40 mol % to 75 mol % of one or more semi-aromatic units (s),
of 20 mol % to 50 mol % of one or more aliphatic units (a), and
of 0 to 20 mol % of one or more units other than the aforesaid units (a) and (s).

6. The structure as claimed in any one of claims 1 to 5, characterized in that the copolyamide (H) is composed:
of 50 mol % to 75 mol % of one or more semi-aromatic units (s), and
of 25 mol % to 50 mol % of one or more aliphatic units (a).

7. The structure as claimed in any one of claims 1 to 6, characterized in that the subunit (sr) is obtained only from terephthalic acid.

8. The structure as claimed in claim 5, characterized in that the copolyamide (H) is selected from PA12/9.T, PA6.12/10.T, PA10.10/10.T, PA10.10/10.T/6.T, PA10.10/10.T/10.I, and PA10.12/10.T.

9. The structure as claimed in any one of claims 1 to 8, characterized in that the composition forming the outer layer (L1) comprises one or more supplementary polymers selected from functionalized or non-functionalized polyolefins, aliphatic polyamides, and mixtures thereof.

10. The structure as claimed in claim 9, characterized in that the polyolefin is a functionalized copolyolefin comprising one or more anhydride or acid functions, optionally in a mixture with at least one polymer comprising one or more epoxide functions.

11. The structure as claimed in any one of claims 1 to 10, characterized in that the composition forming the outer layer (L1) comprises up to 15 wt % of a plasticizer, relative to the total weight of the composition.

12. The structure as claimed in any one of claims 1 to 11, characterized in that it takes the form of a two-layer structure.

13. The structure as claimed in any one of claims 1 to 11, characterized in that it takes the form of a three-layer structure, the interlayer (L3), arranged between the layers (L1) and (L2), it being possible for the interlayer (L3) to comprise one or more aliphatic (co)polyamides comprising between 9 and 36 carbon atoms per nitrogen atom or one or more polyphthalamides.

14. The structure as claimed in any one of claims 1 to 13, characterized in that the composition of the layer (L2) comprises conductive fillers.

15. The structure as claimed in any one of claims 1 to 14, characterized in that when the layer (L2) is composed predominantly of one or of two or more functionalized fluorocopolymers as defined in claim 1, it comprises a supplementary layer located in contact with said layer (L2) and forming the innermost layer of the structure, it being possible for this supplementary layer to comprise one or more non-functionalized fluorocopolymers as defined in claim 1 and, optionally, conductive fillers.

16. A pipe comprising a structure as claimed in any one of claims 1 to 15.

17. The use of a structure as defined in any one of claims 1 to 15 or of a pipe as claimed in claim 16 for transporting polar and/or apolar fluids, especially those present in vehicles.

18. The use as claimed in claim 17, characterized in that the fluid is selected from an oil, a liquid based on urea solution, a fuel, especially an alcoholized fuel and more particularly a biogasoline, a refrigerant fluid, engine gas emanations, and a cooling liquid, more particularly a glycol-based cooling liquid.
